(19) United States
(12) Patent Application Publication
(10) Pub. No.: US 2026/0309192 A1
(43) Pub. Date: Oct. 8, 2026

(54) AXLE SERVICE DISCONNECT WITH SHAFT SUPPORT

(71) Applicant: Magna Powertrain of America, Inc., Troy, MI (US)

(72) Inventors: Alex Sandstrom, Oakland Township, MI (US); Tim Filkins, Auburn Hills, MI (US); Douglas Botto, Royal Oak, MI (US); Michelle Figueroa, Rochester Hills, MI (US); Keith Tousignant, Sterling Heights, MI (US)

(21) Appl. No.: 19/484,955

(22) PCT Filed: May 13, 2024
(86) PCT No.: PCT/US2024/029041

§ 371 Date: Nov. 17, 2025

Related U.S. Application Data
(60) Provisional application No. 63/467,428, filed on May 18, 2023.

(51) Int. Cl. F16D 1/108; B60B 35/12; B60B 35/16; B60B 35/18; F16D 1/10

(52) U.S. Cl. CPC F16D 1/108; B60B 35/121; B60B 35/16; B60B 35/18; F16D 2001/103

(57) ABSTRACT

A full floating axle for an automotive vehicle includes an axle tube, a wheel hub rotationally supported on the axle tube, an axle shaft extended through the axle tube, and an end plate mounted to the axle shaft and the wheel hub. The end plate transmits torque between the axle shaft and the wheel hub when connected. The end plate is disconnectable from the axle shaft and the wheel hub and connectable back onto the wheel hub in a service disconnect mode, such that torque is not transmitted between the wheel hub and the axle shaft. An engaging support feature between the axle shaft and the axle tube has a connected state and a disconnected state. In the connected state, the engaging support feature provides support between the axle shaft and the axle tube. In the disconnected state, there is no contact between the axle shaft and the axle tube.

### FIELD

The present disclosure relates to a design and method to provide a service disconnect for full float wheel ends. The wheel end design is modified to allow for disconnect functionality via a simple removal of components and returns to normal connected operating mode with the reinstallation of components. A feature is included to provide support between the axle shaft and the axle tube when the wheel end is in the service disconnect condition.

### BACKGROUND

This section provides background information related to the present disclosure which is not necessarily prior art.

Electrified versions of heavy-duty vehicles are being developed to take advantage of the reduced emissions and energy consumption they provide. One such example is the integration of an electric motor into a drive axle, such as a beam axle in a higher weight class truck applications. Due to the weight carrying requirements of the vehicle, the rear axle may be designed to utilize full floating wheel ends. These wheel ends are designed so chassis support loads are supported directly onto the axle housing and not through the axle shaft. The axle shaft is solely required to transmit the torque developed from the electric motor via a transmission and distributed to each axle shaft via a differential, resulting in a reduced diameter axle shaft as bending and torsion loading is not combined. In normal full floating wheel ends, a mechanical connection is provided to transmit the torque directly from the axle shaft to the wheel hub and into the ground engaging wheels and tires via a wheel flange formed into the outer extents of the wheel hub. Depending on the end usage of these heavy-duty vehicles, there are situations where the vehicle will be flat towed or front axle lifted towed, resulting in moving the vehicle on its own wheels with the wheels rotating as the vehicle is towed. It is required to provide a disengagement somewhere in the driveline to prevent back driving of the powertrain and other components as it either can result in additional drag or damage. For an electrically driven vehicle it is especially critical to not back drive the driveline and rotate the electric motor during flat towing as this can produce back electromotive force (EMF) or a bus voltage due to rotation of the electrical components, even during a system off operating condition, resulting in strain or damage to the electrical components of the system. In internal combustion engine (ICE) powered vehicles, disconnecting capability can often be provided by existing driveline components (e.g., transfer case neutral position, disengagement of the manual transmission clutch, removal of prop or axle shaft) or implementing manually actuated mechanical wheel end disconnect systems such as those described in U.S. Pat. No. 9,382,951. As the flat towing operation may only occur a few times during the life of the vehicle, it is not cost effective to integrate an additional complicated disconnect system into an electrified beam axle to only be used in the off chance flat towing is required. Also, there is a safety concern to implement manual locking wheel hubs as these can be easily switched to a disconnected mode by anyone via rotating the manual locking wheel hub by hand or by tool resulting in a potential disconnect between the parking lock system and the ground engaging wheels/tires. Depending on the type and angle of surface the vehicle is parked on, the vehicle may roll uncontrollably if the disconnect is easily engaged at an improper time and could result in grave danger to those around the vehicle. There is also a concern that if the end user believes the wheel hub is disconnected but truly is not, further functional safety issues in the operation of the vehicle could occur including unstable operation. Therefore, there is a need to provide an improved wheel end design which can allow for the ability to temporarily provide disconnect capability with some, but minimal, servicing effort required ensuring a disconnect is achieved while resulting in minimal additional component cost to the axle. Note, although these solutions have been created due to requirements of electrified axle systems, the solutions can also be implemented when the wheel ends are driven by other power sources such as internal combustion engines.

### SUMMARY

This section provides a general summary of the many aspects associated with the inventive concepts embodied in the teachings of the present disclosure and is not intended to be considered a complete listing of its full scope of protection nor all of its features and advantages.

It is an aspect of the present disclosure to provide an improved full float wheel end design which can allow a temporary service disconnect between the axle shaft and the wheel hub.

It is a related aspect of the present disclosure to provide an improved full float wheel end design which incorporates a supporting interface between the axle shaft and axle tube to maintain concentric location of the axle shaft relative to the wheel hub and axle tube when the service disconnect is implemented.

It is a related aspect of the present disclosure for the supporting interface between the axle shaft and the axle tube to include an engagement feature which provides support and positively positions axially the axle shaft relative to the axle tube when the service disconnect is utilized in the disconnected mode and the axle shaft has been moved to its service disconnect position.

It is an aspect of the present disclosure to provide a wheel end design where components are removed and/or repositioned and reinstalled to provide for the temporary service disconnect and then can be returned to its original configuration to provide a connected mode for normal operation.

It is a related aspect of the present disclosure to allow the implementation of the service disconnect to use simple mechanical tools to transition between a connected and disconnected mode.

It is a related aspect of the present disclosure to provide an improved wheel end that, if the temporary service disconnect is never utilized, the wheel end will function as normal with no to minimal impacts to overall efficiency, weight, or cost of the axle.

It is a related aspect of the present disclosure to provide an improved wheel end where, when the components are installed in the disconnected mode, the wheel hub cavity remains sealed from the outside environment.

It is a related aspect of the present disclosure to provide an improved wheel end where, when the components are installed in the disconnected mode, the flange cavity remains sealed from the outside environment.

It is a related aspect of the present disclosure to provide a “dry” lubricant free cavity which allows for changeover of the wheel end without losing lubricating oil.

These and other features and advantages of the present disclosure will become more readily appreciated when considered in connection with the following detailed description and drawings.

### BRIEF DESCRIPTION OF THE DRAWINGS

The drawings described herein are for illustrative purposes only of selected embodiments and are not intended to limit the scope of the present disclosure. The inventive concepts associated with the present disclosure will be more readily understood by reference to the following description in combination with the accompanying drawings wherein:

FIG. 1 is cross sectional view of an end portion of an axle and wheel/tire assembly;

FIG. 2A is a view of the first embodiment of the full float wheel assembly with service disconnect, with a shaft support interface in a normal operating mode;

FIG. 2B is a view of the first embodiment of the full float wheel assembly with service disconnect, with the shaft support interface in a service disconnect operating mode;

FIG. 3A is a detailed view of the shaft support interface in the normal operating mode; and

FIG. 3B is a detailed view of the shaft support interface when the service disconnect is implemented.

### DETAILED DESCRIPTION

The present disclosure is related to a design and method to provide a service disconnect for full float wheel end of a beam axle. The wheel end design is modified to allow for disconnect functionality via a simple removal and reinstallation of components and axial movement of the axle shaft towards a supporting feature of the axle tube. It should be appreciated each axle will utilize two wheel ends per axle and the beam axle tube arrangement can be of any configuration including a stamped banjo construction or a tube for a salisbury type axle. The end portion of the beam axle tube may also be referred to a spindle, particularly in a stamped banjo construction axle. A support interface feature has been added between the axle shaft and the axle tube or spindle, to maintain at least an axial and/or radial position of the axle shaft relative to the wheel hub and axle tube when the service disconnect is utilized. The design includes a modified end plate to seal the cavity on the outer end in normal or disconnect mode and is utilized to selectively transmit torque depending on installation position. It is the intention of this disclosure to describe how the design modifications of the proposed arrangement leads to a method of providing a service disconnect by simply removing, reorientating, and reinstalling components in a manner to disrupt torque transfer between the axle shaft and the wheel hub providing a disconnect functionality while also moving the axle shaft outward to engage a support interface feature of the axle tube. When normal operation is again required, simply removing, reorientating, and reinstalling the components back to their original position will result in a connected mode transferring torque from the axle shaft to the wheel once again.

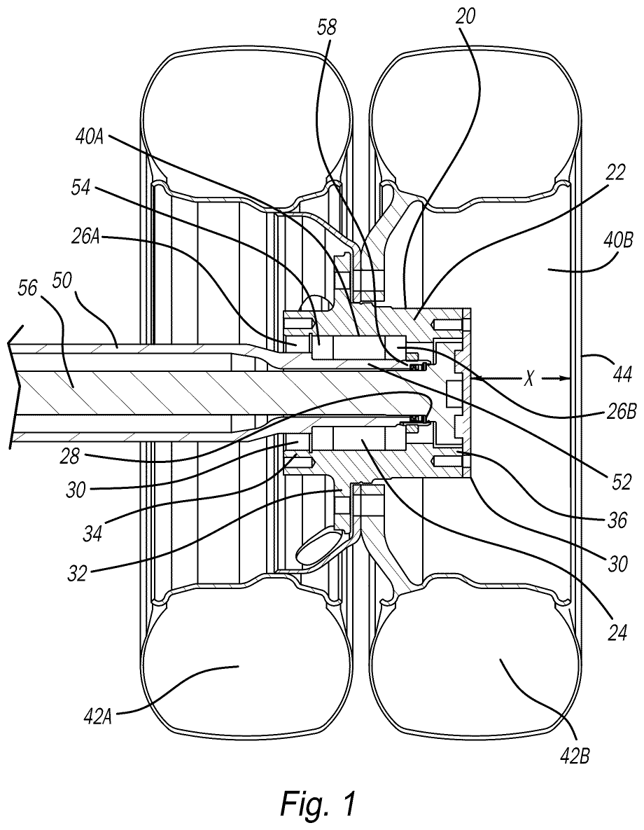

With attention directed to FIG. 1, a cross sectional view of an end portion of an axle, an improved full float wheel end with service disconnect, and an arrangement of the improved wheel end attached to dual wheels is provided. Although a dual wheel arrangement is shown, it should be understood the embodiments of this disclosure can also be utilized in a single wheel configuration. An improved full float wheel hub assembly with service disconnect 20 is provided with the primary components including a wheel hub 22, inboard wheel hub bearing 26A, outboard wheel hub bearing 26B, end plate 30, and inboard wheel hub seal 30. Wheel hub 22 is constructed in a generally hollow cylindrical form with internal wheel hub cavity 24, a radially extending wheel mounting flange 32 and an open first end 34 and open second end 36. At least one wheel 40 with tire 42 mounted on wheel 40 is fixedly attached to wheel flange 32. In this arrangement shown, a dual wheel configuration is utilized where a pair of wheels (40A/40B) are mated to the single wheel flange 32. Note in a dual wheel arrangement due to the outwardly extending position of the outboard wheel 40B and tire 42B, significant open space X is provided between the outboard wheel outer edge 44 and the end plate 30. This open space X may be utilized when repositioning and reinstalling end plate 30 when in service disconnect mode without protruding beyond the outboard wheel outer edge 44 risking potential damage due to an exposed component. Axle tube 50 is provided, entering wheel hub cavity 24 from the first end 34 and extending partially thru wheel hub cavity 24. Inboard wheel hub bearing 26A and outboard wheel hub bearing 26B are positioned on the outer cylindrical surface 52 of axle tube 50 and the inner cylindrical bore 54 of wheel hub 22 to allow for rotation of wheel hub 22 around stationary axle tube 50. Transmittal of chassis loads from components not shown, such as shock mounts and spring mounts, applied between wheel 40 and axle tube 50 are transferred into wheel hub 22 via wheel hub bearings 26A and 26B. Seal 30 is positioned between the inner cylindrical bore 54 and axle tube 50 to seal wheel hub cavity 24 towards wheel hub first end 34. An axle shaft 56 will pass thru the center portion of axle tube 50 without contact, extending beyond the outer end 58 of axle tube 50 entering wheel hub cavity 24.

Continuing to refer to FIG. 1, axle shaft 56 and the end portion of axle tube 50 is different compared to standard full float wheel end in two primary ways. First, axle shaft 56 includes provisions to include an engaging support feature 28. This engaging support feature 28 provides support and maintains location of the axle shaft 56 relative to the axle tube 50 when the service disconnect is implemented and the axle shaft 56 is moved outward, towards hub second end 36, such that the axle shaft 56 is rotationally fixed to the axle tube 50 and does not rotate. When the service disconnect is not utilized, there is no engagement or contact between the axle shaft 56 and the axle tube 50 by the engaging support feature 28, thereby allowing the axle shaft 56 to rotate relative to axle tube 50 and drive the wheels. Secondly, axle shaft 56 differs from standard designs in that it provides no direct torque transmitting connection between the axle shaft 56 and wheel hub 22 second end 36 as is traditionally found in a standard full float wheel hub assembly. In a standard full float wheel hub assembly, the axle shaft extends fully thru wheel hub cavity (similar to 24) and extends radially to mate with the second end (similar to 36) of wheel hub (similar to 22) where fasteners are used to provide a positive torque transmitting connection between the axle shaft and wheel hub, as well as providing sealing for flange cavity (similar to 25) on the second end. Because the improved full float wheel hub assembly with service disconnect 20 of the pre4sent disclosure has a selectable connection between the axle shaft 56 and the wheel hub 22, the present disclosure allows for the use of a removable and/or reconfigurable component to be selectively connected between axle shaft 56 and wheel hub 22 depending on if normal or disconnected operating mode is required. As will be further described, end plate 30 is positioned at the second end 36 of wheel hub 22 to seal hub cavity 24 and flange cavity 25, and is also utilized to transmit torque from axle shaft 56 to wheel hub 22 when connected to drive the wheels in a connected state.

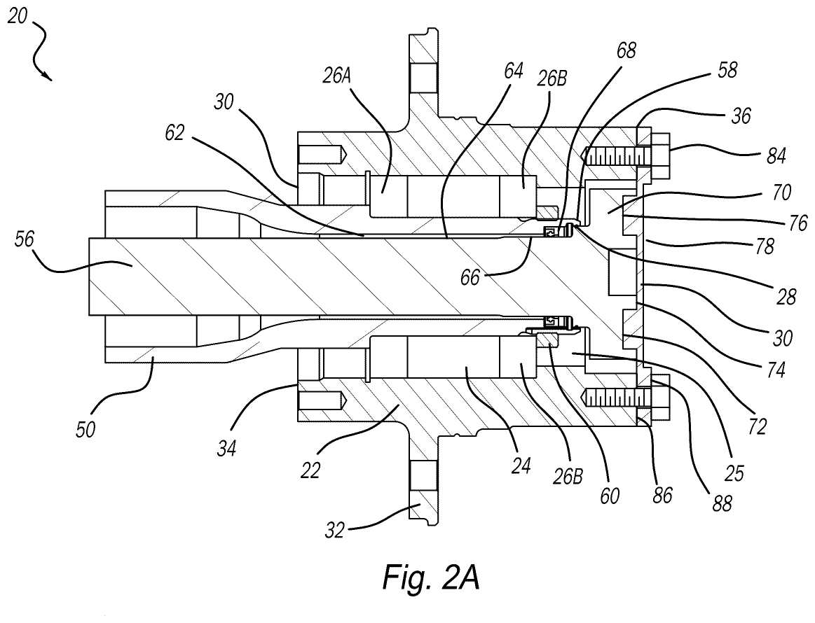

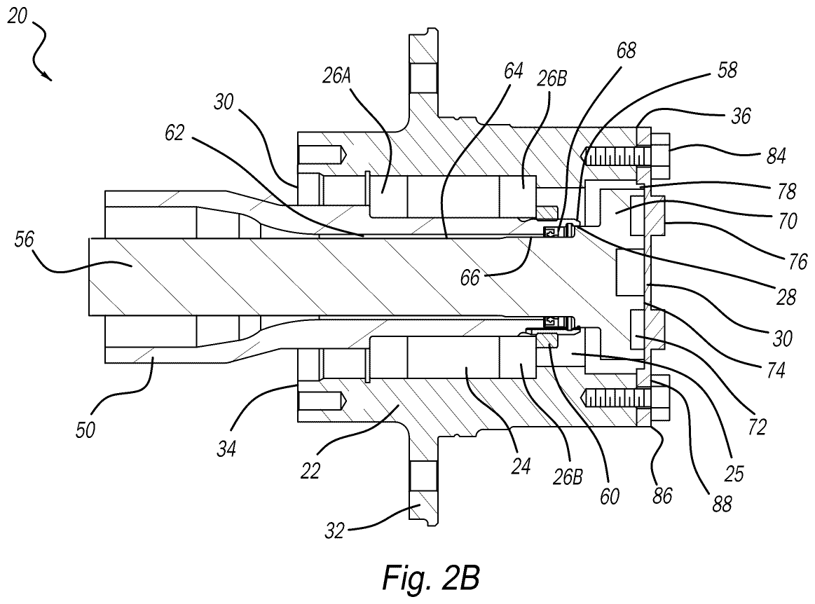

Referring now to FIGS. 2A and 2B, the full float assembly with service disconnect 20 will be further described. FIG. 2A represents the assembly 20 in a normal torque transmitting arrangement between axle shaft 56 and the wheel hub 22, while FIG. 2B represents assembly 20 in the service disconnect mode, with axle shaft 56 engaged with axle tube 50 and in a non-torque transmitting arrangement with wheel hub 22. Inboard wheel hub bearing 26A and outboard wheel hub bearing 26B are taper bearings, in one aspect, although other bearing arrangements could be utilized. In one aspect, inboard wheel hub bearing 26A and outboard wheel hub bearing 26B are lubricated by grease packed into the bearing during initial assembly of the improved full float wheel end 20. A threaded lock nut 60 installed on a threaded end portion of axle tube 50 fixes outboard wheel hub bearing 26B in an axial location and provides a preload to both taper bearings 26 as required for proper operation. Because axle shaft 56 is positioned centrally in axle tube 50 and is normally supported by end plate 30 at the outer end, and on an inboard end by the differential side gear connection (not shown), an axle shaft cavity 62 (having an annular shape) is formed between the axle tube inner diameter 64 and the axle shaft outer diameter 66. Because this cavity 62 communicates with the gearbox and differential of the beam axle, lubricating oil can flow towards the outer end 58 of axle tube 50. To prevent oil from entering the wheel hub cavity 24, a shaft seal 68 is positioned between the axle tube 50 and the axle shaft 56. This results in wheel hub cavity 24 and flange cavity 25 to be a “dry” lubricant free cavity with only grease at the wheel hub bearings 26. Creating the “dry” lubricant free cavities 24 and 25 provides the ability to implement a service disconnect, because lubricating oil will not be lost during the transition from normal mode to disconnect mode or vice versa.

Axle shaft 56 includes a radially extending flange portion 70 with a plurality of pockets 72 formed into the axle shaft outer face 74. These pockets 72 receive axial teeth 76, which extend from end plate inner face 86. Axial teeth 76 are positioned at a diameter no larger than the flange portion 70 of axle shaft 56, because the engagement of axial teeth 76 into pockets 72 is used to transmit torque from axle shaft 56 to end plate 30 when in a normal connected operating mode. An alternative torque transferring feature could be utilized including splines on inner or outer surfaces instead of on the vertical faces as shown. To transmit the torque provided from axle shaft 56 and endplate 30 to wheel hub 22, end plate 30 is fastened to wheel hub 22 via a plurality of fasteners 84 on the hub second end 36. Therefore, in a normal operating mode power provided by the differential will be transferred from axle shaft 56, thru end plate 30, into wheel hub 22, and onto ground engaging wheel 40 and tire 42 via wheel flange 32. On the end plate outer face 88, a recess feature 78 in the central portion of end plate 30 is provided, which is utilized when end plate 30 is positioned in the service disconnect mode orientation.

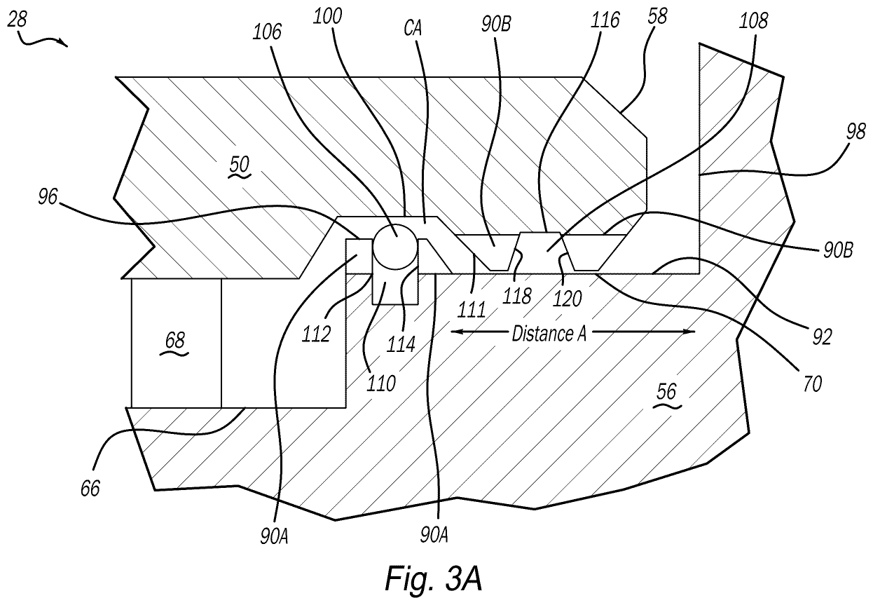

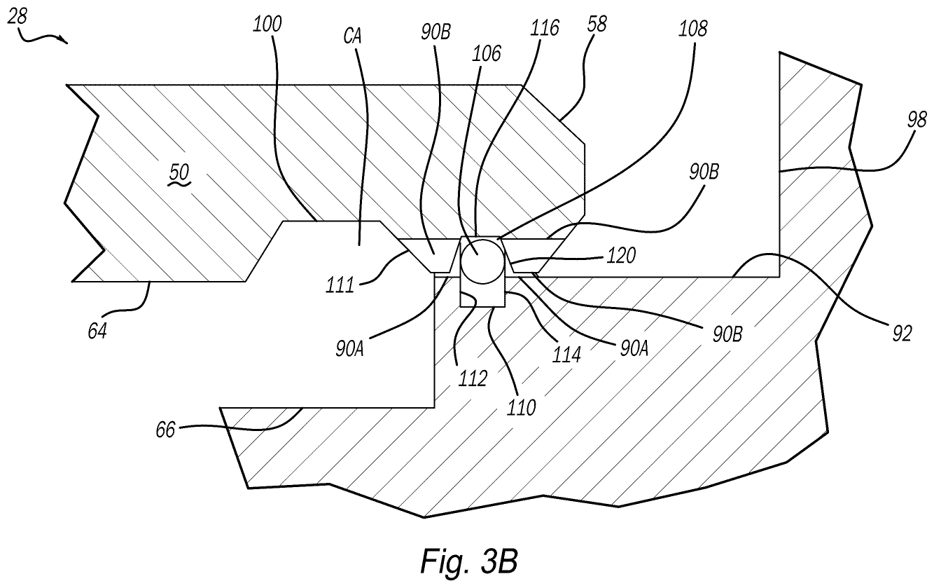

Axle shaft 56 and axle tube 50 also incorporate engaging support feature 28. Engaging support feature 28 provides the following structural and correspondingly functional characteristics. When the system is operating in a normal mode, therefore transferring torque from axle shaft 56 into wheel hub 22, the engaging support feature 28 will not operate to provide an engagement between axle shaft 56 and axle tube 50, and no contact is present between axle shaft 56 and axle tube 50. In this normal mode, axle shaft 56 is in a first position, being a first axial position, where an inward end of axle shaft 56 is fully engaged into the differential located at the center of the beam axle and the axle shaft 56 outward end is engaged with end plate 30. When service disconnect mode is implemented axle shaft 56 is shifted slightly outward, although at a distance that does not cause disengagement from the differential but does allow engaging support feature 28 to create contact and engagement between axle shaft 56 and axle tube 50, providing at least a radial support between axle shaft 56 and axle tube 50. The engaging support feature 28 may also provide a positive engagement fixing the axial position of axle shaft 56 in this extended second position relative to the axle tube 50 while the hub 20 is in service disconnect mode. Details of the engaging support feature 28 will be further shown and described in FIGS. 3A and 3B.

End plate 30 may be initially installed for a connected mode as shown in FIG. 2A, where axial teeth 76, which extend towards flange cavity 25 from end plate inner face 86, are positively engaged to the plurality of pockets 72 on the outer face 74 of axle shaft 56 in a torque transmitting manner. A plurality of fasteners 84 are be used to tightly secure the end plate inner face 86 to the wheel hub second end 36. Optionally a gasket, o-ring, sealant, or other sealing method can be used to further seal end plate inner face 86 to wheel hub second end 36 if required. Torque is transmitted from axle shaft 56, thru axial teeth 76 and pockets 72, into end plate 30, and into wheel hub 22 via fasteners 84 in this connected mode during normal driving operation.

To transition to a service disconnect mode shown in FIG. 2B, fasteners 84 are removed and end plate 30 is separated away from the wheel hub second end 36. End plate 30 is then flipped in position and reinstalled, now with axially extending teeth 76 facing outboard or away from the wheel hub second end 36 and flange cavity 25. Axle shaft 56 is pulled or shifted slightly outward (relative to the differential) to its service disconnect position, where the axle shaft outer face 74 of axle shaft 56 becomes axially aligned or slightly proud to hub second end 36. A positive engagement of engaging support feature 28 may be detected, such as being felt manually, to confirm that the axle shaft 56 has been properly moved to its second, service disconnect position. Shaft seal 68 remains in contact with axle shaft outer diameter 66 to block oil from leaking out of axle shaft cavity 62. End plate 30 is installed in an opposite orientation, and therefore the originally end plate outer face 88 is now in contact with hub second end 36 and recess 78 is facing inwards towards wheel hub 22. Recess 78 ensures an axial gap AG is provided and no contact is made between end plate 30 and axle shaft 56, which is now in its second extended position, axially shifted from its initial position. In this arrangement, end plate 30 is no longer be engaged to axle shaft 56, thereby providing a non-torque transferring disconnect between the axle shaft 56 and wheel hub 22. Fasteners 84 are reinstalled to tightly secure end plate outer face 88 to wheel hub second end 36, resealing wheel hub cavity 24 and flange cavity 25.

Once the service disconnect mode is no longer desired, the steps above are be performed in the opposite manner to return to the configuration shown in FIG. 2A. These steps include disengaging the engaging support feature 28 between axle shaft 56 and axle tube 50 by overcoming the positive locating feature, and returning axle shaft 56 to its normal operating position. This may be achieved by manually applying force to axle shaft outer face 74 or relying on end plate 30 to force axle shaft 56 into its normal position when end plate 30 is clamped down to hub second end 36 with fasteners 84. Either operation will move axle shaft 56 axially inward towards the center of the beam axle. This operation is performed for both left and right axle shafts and wheel ends of the beam axle. Additionally, it is verified that the axially extending teeth 76 of end plate 30 are properly aligned and fully engaged with pockets 72 to create the torque transmitting arrangement required in a normal operating mode between axle shaft 56, end plate 30, and wheel hub 22.

Turning attention now to FIG. 3A and FIG. 3B, details of one example of the engaging support feature 28 are provided. FIG. 3A represents the engaging support feature 28 in a normal operating condition, while FIG. 3B represents engaging support feature 28 in the service disconnect mode. Note this is an example of an implementation which would provide no engagement and no torque transmitting contact between axle shaft 56 and axle tube 50 in a normal operating mode, while providing radial support between axle shaft 56 and axle tube 50 when in the disconnect mode. The engaging support feature 28 shown also provides a positive engagement, fixing the axial position of axle shaft 56 in the extended second position relative to the axle tube 50 while the hub 20 is in service disconnect mode. While in service disconnect mode, it is preferred no relative rotation is allowed between axle shaft 56 and axle tube 50, but it would not be detrimental if the components were not fixed together as provided in this example. Other designs and methods achieving the same functionality could be devised, and this example should not be considered the only arrangement to achieve such requirements.

To achieve this functionality, in one aspect, a spline 90 may be used between axle shaft 56 and axle tube 50. Spline 90A is defined as the outer spline portion included in axle shaft 56, while spline 90B is designated as the inner spline of axle tube 50. Spline 90B is located at axle tube outer end 58 as the last feature at the end of axle tube 50, while spline 90A is located inboard or further towards the center of the axle when compared to spline 90B when in the normal operating position. In other words, spline 90A will be located between shaft seal 68 and flange portion 70. Spline 90A may have a pitch diameter larger than axle shaft outer diameter 66 but smaller than the diameter of flange portion 70. In this arrangement, journal 92 may be provided at a diameter larger than axle shaft outer diameter 66 where spline 90A minor diameter 94 may be approximately equal to journal 92 diameter. Spline 90A may have a major diameter 96 which may be diametrically larger than journal 92 and sufficient to provide for a proper spline tooth height. Spline 90A may be located inward from inner flange face 98 of flange portion 70 at a distance A from face 98. The location of spline 90A distance A away from face 98 provides an area diametrically outward of journal 92 where spline 90B of axle tube 56 may be positioned to ensure no engagement between spline 90A and 90B occurs when axle shaft 56 is in its normal operating location. Similarly, towards the end of axle tube 50, a clearance area CA is provided on the inner surface in axle tube 50 to ensure no contact is made between spline 90A and axle tube 50 inner diameter when axle shaft 56 is in its normal operating location. Clearance area CA is provided by including a recess diameter 100 in axle tube 50 which is greater than the major diameter 96 of spline 90A. Spline 90B will include a minor diameter 102 which may be similar to axle tube inner diameter 64 but will be slightly larger than spline 90A minor diameter 94 and journal diameter 92. Spline 90B has a major diameter 104 slightly larger or the same as the major diameter 96 of spline 90A. This ensures inner spline 90A of axle shaft 56 can engage into outer spline 90B of axle tube 56 when axle shaft 56 is moved outward. Spline 90 can provide either a side fit or major diameter fit, providing appropriate support of axle shaft 56 to axle tube 50 when in service disconnect mode. The support provided by spline 90 ensures no damage to shaft seal 68 when axle shaft 56 is not engaged to end plate 30 by being unsupported. As axle shaft 56 moves relative to axle tube 50 during normal operation, it may be required to slightly rotate axle shaft 56 when implementing the service disconnect mode to rotationally align the teeth of spline 90A to the slots of spline 90B to allow axle shaft 56 to be pulled outwards, thereby engaging spline 90A into spline 90B.

Continuing to refer to FIGS. 3A and 3B, the engaging support feature 28, which ensures axle shaft 56 maintains its axial position relative to axle tube 50 when in service disconnect mode, is further described. Within spline 90A, a circlip 106 is positioned, and is used to engage into a tube groove 108 in the axle tube 50 (and within the spline 90B) to maintain axial position between the axle tube 50 and axle shaft 56 when in the service disconnect position. FIG. 3A shows splines 90A and 90B, as well as axle shaft 56 and axle tube 50, in the normal operating mode where no contact is made. In this figure, circlip 106 is shown installed into a shaft groove 110, which is provided approximately in the middle of inner spline 90A. Circlip 106 is installed into the shaft groove 110 which is open at the major diameter 96 surface of inner spline 90A and extends to a depth below spline 90A minor diameter 94 to a depth or diameter sufficient to fully receive circlip 106. Shaft groove 110 is defined further by an inner side 112 and an outer side 114. Similar to shaft groove 110, tube groove 108 is provided in the outer spline 90B of axle tube 50. Tube groove 108 has an outer diameter 116 that is approximately the same as the major diameter 104 of spline 90B. Shaft groove 108 is open at spline 90B minor diameter 102, allowing tube groove 108 to receive circlip 106 when in the engaged, service disconnect position.

Circlip 106 may be a circular cross section ring with properties that allow, in its unloaded condition, to expand to a diameter approximately equivalent to the major diameter 96 of spline 90A. Circlip 106 may include a gap about its circumference which allows circlip 106 to be compressed smaller than its unloaded state and allow the circlip diameter to be reduced when load is applied towards its outer extents. In this arrangement, load will be applied by the combination of the force pulling axle shaft 56 outwards when transitioning to a service disconnect mode and the angular features of axle tube 50. Axle tube 50 may include angular faces within the clearance area A and tube groove 108 to assist in compressing circlip 106 when axle shaft 56 is moved between the normal operating position and the service disconnect position. Referring to FIG. 3A, as axle shaft 50 is moved outward or towards the right in the view of the figure, spline 90A will move towards spline 90B, and eventually the engaging angular face 111 of axle tube 50 will contact circlip 106. Due to the angle of face 111, an angled force is applied to circlip 106 compressing and reducing the overall diameter of circlip 106. As spline 90A continues to engage spline 90B, circlip 106 will be reduced to an outer diameter smaller than the minor diameter 102 of spline 90B. Minor diameter 102 will continue to force circlip 106 downward, now with the force component being mostly perpendicular towards the center of axle shaft 56, resulting in circlip 106 being compressed into shaft groove 110 allowing further engagement of spline 90A into spline 90B. Axle shaft 56 will continue to move until spline 90A and 90B are generally fully engaged, at which point grooves 108 and 110 will align. In this alignment, because no force is applied to circlip 106 once grooves 108 and 110 are aligned, circlip 106 will spring back to its larger non-loaded diameter. This radially outward movement results in circlip 106 being captured within both the shaft groove 108 and the tube groove 108, thereby preventing or substantially limiting axial movement between axle shaft 56 and axle tube 50, as shown in FIG. 3B.

To return to a normal operating condition, axle shaft 56 must overcome being constrained axially by circlip 106 and its interaction between grooves 108 and 110. Tube groove 108 includes side walls 118 and 120, where at least wall 118 has an angled, non-perpendicular relationship to the axle tube spline 90B minor diameter 108. This angled arrangement allows a similar interaction to circlip 106 as described earlier with angular face 111. Circlip 106 will again be compressed to a diameter smaller than its unloaded state and allow the circlip diameter to be reduced to less than tube spline 90B minor diameter 102. As axle shaft 56 is moved inward, spline 90A will begin disengagement from spline 90B. As axle shaft 56 is moved inwards to return to its normal operating position, angled wall 118 will apply an angled force to circlip 106 compressing and reducing the overall diameter of circlip 106. As spline 90A continues to disengage from spline 90B, circlip 106 will again be reduced to an outer diameter smaller than the minor diameter 102 of spline 90B. Minor diameter 102 will continue to force circlip 106 downward resulting in circlip 106 being compressed into shaft groove 110, thereby allowing further disengagement of spline 90A from spline 90B. Axle shaft 56 will continue to move inward until circlip 106 is beyond minor diameter 102 on the inboard side of spline 90B and may expand into clearance area CA. At this point spline 90A and 90B are fully disengaged and have been returned to the normal operating position where no contact occurs between axle shaft 56 and axle tube 50 as shown in FIG. 3A. The use of a circlip and groove arrangement is one example to maintain axle shaft 56 position relative to axle tube 50 and wheel hub 22, but other solutions which achieve similar functionality could also be used. It will be appreciated that FIG. 3A illustrate the minor diameter of spline 90B being very close to the outer diameter of the journal 92 at the end of the axle shaft 56. However, as described above, the axle shaft 56 in the normal operating condition is fixedly coupled to the wheel hub 22, which is supported from rotation on the axle tube 50 via bearings. Thus, there is no contact, rotational support, radial forces, or friction that occurs at the location of the journal 92 and the spine 90B in the normal operating condition. Such support occurs via the splines 90A and 90B in the service disconnect position of FIG. 3B.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varies in many ways. Such variations are not to be regarded as a departure from the disclosure, and all such modifications are intended to be included within the scope of disclosure.

What is claimed is:

1. A full floating axle for an automotive vehicle, said axle comprising:
an axle tube with an outboard end;
a wheel hub radially and rotationally supported on the axle tube;
a bearing arrangement at the outboard end of the axle tube supporting the wheel hub;
an axle shaft extended through the axle tube and radially within the wheel hub;
an end plate mounted to the axle shaft and the wheel hub, wherein the end plate transmits torque between the axle shaft and the wheel hub when connected therebetween, wherein the end plate is disconnectable from both the axle shaft and the wheel hub, such that torque is not transmitted between the wheel hub and the axle shaft;
an engaging support feature disposed radially between the axle shaft and the axle tube and having a connected state and a disconnected state, wherein the engaging support feature is shiftable between the connected state and the disconnected state;
wherein in the connected state of the engaging support feature, the engaging support feature provides support and contact between the axle shaft and the axle tube, and
wherein, in the disconnected state of the engaging support feature, there is no contact between the axle shaft and the axle tube and no support is provided between the axle shaft and the axle tube by the engaging support feature.

2. The axle of claim 1, wherein the engaging support feature includes a splined connection configured to shift axially.

3. The axle of claim 2, wherein the splined connection includes an axle shaft spline with axle shaft spline teeth extending radially outward from the axle shaft and an axle tube spline including axle tube spline teeth extending radially inward from the axle tube.

4. The axle of claim 3, wherein the axle shaft spline is disposed axially inward relative to the axle tube spline in the disconnected state.

5. The axle of claim 4, wherein the axle shaft spline is disposed within a clearance area formed in the inner surface of the axle tube that is axially adjacent the axle tube spline in the disconnected state.

6. The axle of claim 5, wherein the axle tube spline is disposed in an annular space defined axially between axle shaft and a flange portion at the outer end of the axle shaft in the disconnected state.

7. The axle of claim 4, wherein the axle shaft is shifted axially outward relative to the axle tube in the connected state, wherein the axle shaft spline is axially received in the axle tube spline to provide radial support therebetween.

8. The axle of claim 2, wherein the splined connection additionally provides axial support between the axle shaft and the tube in the connected state.

9. The axle of claim 8, wherein the axle tube shaft spline defines a shaft groove and the axle tube spline defines a tube groove, wherein a circlip is disposed within the shaft groove and configured to compress and expand into the tube groove in the connected state to axially locate the axle shaft relative to the axle tube.

10. The axle of claim 1, wherein the end plate connects the wheel hub and the axle shaft in a normal operating mode and transmits torque therebetween.

11. The axle of claim 10,
wherein the axle includes a service disconnect mode, in which the end plate does not connect the wheel hub and the axle shaft, such that rotation of the wheel hub does not transfer torque to the axle shaft;
wherein the end plate has a first orientation in the normal operating mode and a second orientation, flipped relative to the first orientation, in the service disconnect mode, wherein the end plate connects the wheel hub and the axle shaft in the first orientation, and the end plate is attached to the wheel hub but disconnected from the axle shaft in the second orientation.

12. A full floating axle for an automotive vehicle, said axle comprising:
an axle tube with an outboard end;
a wheel hub radially and rotationally supported on the axle tube;
a bearing arrangement at the outboard end of the axle tube supporting the wheel hub;
an axle shaft extended through the axle tube and radially within the wheel hub;
an end plate mounted to the axle shaft and the wheel hub, wherein the end plate transmits torque between the axle shaft and the wheel hub when connected therebetween, wherein the end plate is disconnectable from both the axle shaft and the wheel hub, such that torque is not transmitted between the wheel hub and the axle shaft;
wherein the axle includes a service disconnect mode, in which the end plate does not connect the wheel hub and the axle shaft, such that rotation of the wheel hub does not transfer torque to the axle shaft;
wherein the end plate has a first orientation in the normal operating mode and a second orientation, flipped relative to the first orientation, in the service disconnect mode, wherein the end plate connects the wheel hub and the axle shaft in the first orientation, and the end plate is attached to the wheel hub but disconnected from the axle shaft in the second orientation.

13. The axle of claim 12, wherein the end plate includes axially extending teeth that engage with pockets formed in an outer face of the axle shaft in the first orientation.

14. The axle of claim 13, wherein the end plate includes a recess formed in a surface axially opposite the axially extending teeth, wherein the recess faces the outer face of the axle shaft in the second orientation, wherein the axle shaft is shifted axially toward the recess in the service disconnect mode.

15. The axle of claim 1, wherein the wheel hub defines a hub cavity between the wheel hub and the axle shaft and a flange cavity between the wheel hub, axle tube, and axle shaft, wherein the wheel hub is sealed at one end via an inboard hub seal disposed radially between the wheel hub and the axle tube, wherein a shaft seal is disposed between the axle shaft and the axle tube, and wherein the end plate provides a seal between the wheel hub and the axle shaft, such that oil from an axle shaft cavity is blocked by the shaft seal, and outside debris is blocked by the end cap and the inboard hub seal.

16. A method of operating the axle of claim 1 in a normal operating mode and a service disconnect mode, the method comprising:
transferring torque between the axle shaft and the wheel hub in the normal operating mode, wherein the wheel hub and the axle shaft rotate together, and the axle shaft and wheel hub rotate relative to the axle tube;
disconnecting the axle shaft from the wheel hub in the service connect mode, such that torque does not transfer between the wheel hub and the axle shaft,
disconnecting the end plate from the wheel hub and the axle shaft;
shifting the axle shaft axially outwardly relative to the axle tube, and radially supporting the axle shaft on the axle tube;
shifting the engaging support feature from the disconnected state to the connected state in response to shifting the axle shaft axially outward, and providing contact between the axle shaft and the axle tube; and
rotating the wheel hub relative to the axle tube and the axle shaft without transferring torque therebetween.

17. The method of claim 16, further comprising flipping the end plate and connecting the end plate to the wheel hub in the service disconnect mode, wherein the end plate rotates with the wheel hub relative to the axle shaft.

18. The method of claim 16, wherein the wheel hub and axle shaft rotate relative to the axle hub without the axle shaft contacting the axle tube.

19. The method of claim 16, wherein the engaging support feature includes a circlip that axially indexes the axle shaft relative to the axle shaft in the service disconnect mode.

20. The method of claim 16, wherein the engaging support feature is a splined connection between the axle shaft and the axle tube, wherein the splined connection provides radial support and rotationally fixes the axle shaft relative to the axle tube.
